(19) United States
(12) Patent Application Publication
(10) Pub. No.: US 2026/0155987 A1
(43) Pub. Date: Jun. 4, 2026

(54) SYSTEMS AND METHODS FOR UPDATING ENCRYPTED DATA COMPONENTS

(71) Applicant: MASTERCARD INTERNATIONAL INCORPORATED, PURCHASE, NY (US)

(72) Inventors: Subbiah Viswanathan, O'Fallon, MO (US); Brandon Eisenbath, O'Fallon, MO (US); Erik Hefferly, St. Peters, MO (US)

(21) Appl. No.: 18/968,490

(22) Filed: Dec. 4, 2024

(51) Int. Cl. H04L 9/32

(52) U.S. Cl. CPC H04L 9/3236

(57) ABSTRACT

Systems and methods are provided for updating supplemental data in a data structure with encrypted identifiers. One example system includes a computing device including a memory having a data structure and a processor, which is coupled to the memory and configured, by executable instructions, to: determine whether a native segment of a starting identifier is the same as a native segment of an ending identifier and, in response to the native segment of the starting identifier being the same as the native segment of the ending identifier: (i) generate a hash value for each hash segment of the range of identifiers; and (ii) update supplemental data, for each entry of the data structure which includes the native segment of the starting identifier and one of the generated hash values for the range of identifiers, without decrypting an encrypted one of the range of identifiers in said entry.

### FIELD

The present disclosure generally relates to systems and methods for updating encrypted data components and, in particular, to systems and methods for updating supplemental data in data structures including encrypted identifiers.

### BACKGROUND

This section provides background information related to the present disclosure which is not necessarily prior art.

In assembling data structures, data is stored in a variety of manners. Some data is stored in a native form, which may be accessed at will. Alternatively, data may be stored in an encrypted form for purposes of securing the data. Subsequently, from time to time, the data included in the data structures (or associated data) may be updated (e.g., replaced, incremented, etc.) for one or more reasons. In connection therewith, the data stored in encrypted form is known to be decrypted before the data can be updated, while the data stored in native form is readily updated.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in updating supplemental data;

FIG. 2 is a block diagram of an example computing device that may be used in the system of FIG. 1; and

FIG. 3 is an example method that may be implemented in connection with the system of FIG. 1 for use in updating supplemental data in a data structure with encrypted identifiers.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Data structures may include a variety of information, which is organized by identifiers. Accounts, for example, may be identified by unique identifiers, and data associated with the accounts may then be included in a data structure in entries including the identifiers. For a payment account, the data may include one or more identifiers, including, for example, issuer designators, account type/classes, preferences, regions/locations, currency type, etc. Often, the identifiers (e.g., account numbers, etc.) are sensitive information, whereby one or more applicable regulations, standards, etc., require the identifiers to be encrypted when stored in the data structure, or potentially, to omit a segment of the account numbers (e.g., XXXX-XXXX-XXXX-1234, where the first twelve digits are omitted/masked, etc.). Consequently, when the data associated with the identifiers or underlying accounts, which may be referenced to as supplemental data (i.e., data not including the identifier), needs to be modified, revised, changed, etc., or broadly, updated, the identifiers must be decrypted in order to properly identify the entries in the data structure (and supplemental data) to be updated. In data structures having thousands or millions of entries, the decryption of the identifier requires substantial processing resources and time.

Uniquely, the systems and methods herein provide for updating supplemental data in a data structure with encrypted identifiers, without decrypting the identifiers.

In particular, in connection with an update instruction for one or more ranges of identifiers, a data repository includes a data structure to which the update instruction is directed. The data structure includes, by applicable restriction(s), the complete identifiers only in encrypted form, but further include a segment of the identifier in native form and a hash of a hash segment of the identifier. The data repository then leverages, for each identifier entry in the data structure, the native segment of the identifier included in the update and also a hash value for a hash segment of the identifier. In this way, by applying specific logic to identifiers in the data structure, the data repository is permitted to identify entries in the data structure specific to the identifiers in the range of identifiers of the update instruction and to alter supplemental data in those entries, without decrypting the encrypted identifier also included in the entry.

Consequently, in response to the update instruction, the update of the supplemental data in the data structure is accomplished accurately while preserving substantial processing resources by avoiding decryption of the encrypted identifier to identify entries therein relevant to the update instruction. Subsequent operations directed to the data structure may then be performed accurately and more expeditiously, which require reliance on the supplemental data in the updated entries of the data structure.

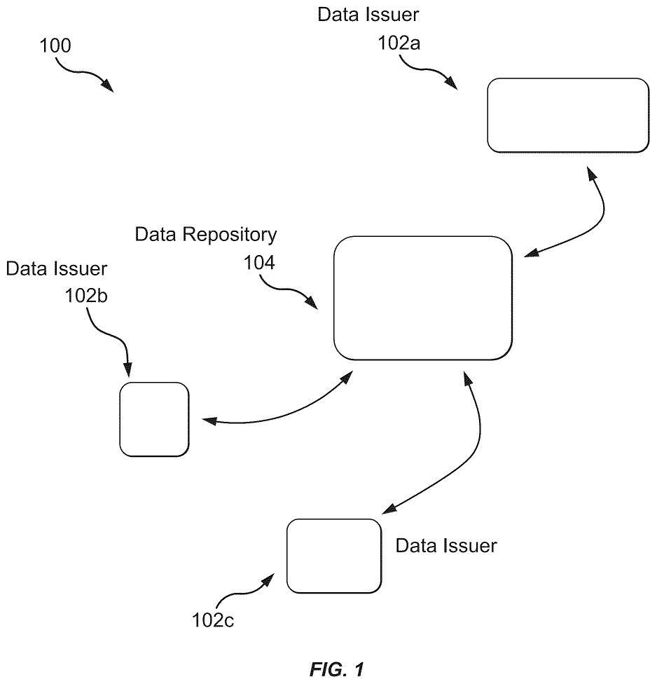

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, types of data, privacy rules and regulations, etc.

The illustrated system 100 generally includes multiple data issuers 102a-c and a data repository 104, each of which is coupled to (and is in communication with) a network. The network (as generally represented by the arrowed lines in FIG. 1) may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. In addition, in some examples, the network may include multiple different networks, such as a private payment and, separately, a public Internet, etc.

In this example embodiment, the data issuers 102a-c each include an institution, which is configured to generate account numbers, or identifiers, that are specific to users. The account numbers may include, for example, primary account numbers, or PANs, specific to financial accounts, whereby in such example the institutions are financial institutions. That said, other types of identifiers may be generated by the data issuers 102a-c for various implementations. In general, however, the identifiers include a specific format, such as a string of characters, which may be numeric, alpha, or alpha-numeric. In one example, the format of a PAN identifier includes between sixteen and nineteen numeric digits, which are, in turn, unique to a payment account.

Each of the data issuers 102a-c is configured to share the identifiers for use of the accounts associated with the identifiers. In doing so, the data issuers 102a-c, or another party (not shown), may impose restrictions on the storage of the identifiers. The restrictions may be compiled into one or more standards applicable to storage of the identifiers. For example, in connection with payment information, one example standard includes the Payment Card Industry Data Security Standard (PCI DSS). The PIC DSS defines, in part, a requirement that PANs, in whole, be stored in encrypted form, but also permits partial PANs to be stored in native form. The data issuers 102a-c, in turn, may be configured to limit sharing of the identifiers based on consent to be bound by the appropriate restrictions, standards, etc.

In connection with the above, the data issuers 102a-c are configured to generate identifiers in manners whereby the identifiers are unique. That is, in this example embodiment, each of the data issuers 102a-c is assigned a range of identifiers, within which identifiers may be generated by the data issuers 102a-c. In one example, the data repository 104, or an associated institution (e.g., a processing network (e.g., MASTERCARD, VISA, AMERICAN EXPRESS, etc.), a standards organization, etc.), may be configured to define the ranges. Table 1 illustrates an example range of identifiers for each of the data issuers 102a-c. It should be appreciated that the range may be different depending on the format of the identifiers, and the number of identifiers required or desired by the data issuers 102a-c (or for which the data issuers 102a-c are capable of generating (e.g., identifier demand for the data generator, etc.), etc.).

TABLE 1

| | ID_1 | ID_2 | Range |
|---|---|---|---|
| Data Issuer 102a | 1234 | 1234 | 5555 5555 5500 0000-5555 5555 5570 0000 |
| Data Issuer 102b | 3465 | 2345 | 5555 5555 5580 0000-5555 5555 5581 0000 |
| Data Issuer 102c | 1234 | 1239 | 5555 5555 5582 0000-5555 5555 5590 0000 |

In addition to the range, Table 1 also includes designators for the data issuers 102a-c. The ID_1 is a top-level designator, and ID_2 is a second level designator. For example, the top-level designator may indicate a unique institution (e.g., 1234 is Bank ABC, etc.), and the second level designator may indicate a specific branch or location of the institution (e.g., 1234 is 101 Main St, while 1239 is 150 5^{th} St., etc.). It should be appreciated that other designators, or data, may also be associated with the identifier ranges.

While only three data issuers 102a-c are illustrated in FIG. 1, it should be appreciated that system embodiments may include any number of data issuers.

In this example embodiment, the data repository 104 is configured to store multiple identifiers generated by the data issuers 102a-c.

In connection therewith, the data repository 104 is configured to receive the identifiers from the data issuers 102a-c, another party (e.g., a merchant, an acquirer bank, etc.), or users to which the identifiers are assigned (e.g., account holders, etc.). In response, the data repository 104 is configured to store the identifiers in a database, as part of a data structure (e.g., a table, etc.). An example data structure is included in Table 2 below. As shown, the identifiers are PANs, each of which should be understood to be unique to a payment account. The identifiers are stored along with supplemental data, such as, for example, the one or more designators of the data issuers 102a-c, etc.

TABLE 2

| Encrypted | Leading 10 | Hashed 11 | | |
|---|---|---|---|---|
| Identifier | Digits | Digits | ID_1 | ID_2 |
| fgegrqhruislhdhte | 5555 5555 55 | jhgneygd | 1234 | 1234 |
| oingrqhrnbhdhdie | 5555 5555 47 | qwkyehdi | 4567 | 2355 |

Table 2 illustrates a data structure in which the identifiers are stored. As shown, the data structure does not include the identifiers in native form. As such, in connection with storing the “identifiers” in the data structure, the data repository 104 is configured to encrypt the identifiers, based on one or more encryption algorithms applied to the native form of the identifiers, and to store the encrypted identifiers in the data structure (or data repository 104). In addition, the data repository 104 is configured to generate a hash value for the first segment of the PAN, which in this example is the leading eleven digits of the identifier, and to store the hashed first segment in the data structure. The hash value is generated, by the data repository 104, for example, based on a one-way hash of the hash segment of the identifier (i.e., a native version of the identifier), such as, for example, SHA-1, SHA-256, MD4, MD5 or variations thereof, etc. Also, the data repository 104 is configured to store a second segment of the identifier in native form, which, in this example, includes the leading ten digits.

It should be appreciated that the first segments and the second segments of the identifiers may be a different number of characters in other embodiments. In general, however, the second segments (i.e., the native segments) are shorter than the first segments (i.e., the hash segments). In this example, the second or native segments are a length defined by one or more applicable standards, as the number of digits permitted to be stored in native form. Similarly, the first or hash segments are a length defined by the one or more standard, as the number of digits permitted to be stored in native form, plus one.

It should also be appreciated that the hash segments include the segment of the identifier that is necessary, in various embodiments, to differentiate one range of identifiers from another. So, for example, where the identifier is a 16 digit PAN, which may be divided into ranges of 10,000 identifiers, the 12th digit of the identifier would be unique to the data issuer(s) 102a-c to which the range is assigned. As such, the data repository 104 is configured to hash out the native segment of ten, which gives rise to ninety-nine potential values (i.e., the eleventh and twelfth digits, etc. This is a substantial processing and time savings over the decryption of each identifier from the 16 digit PAN. Consequently, in this example, the hash segment of the identifier is then twelve digits.

With reference to Table 2, it should further be appreciated that additional supplemental data may be included in the data structure/data repository 104, which may be used, for example, to identify the data issuers 102a-c for the identifiers.

With the common format of the identifiers among the data issuers 102a-c, there are a limited number of identifiers. For example, for a nine digit format, there are only nine hundred million unique identifiers to be assigned. As such, the identifiers, or more specifically, ranges of identifiers, may be reassigned from one data generator to another. The range of identifiers is denoted by a starting identifier and an ending identifier, where each may be a specific identifier, or a segment of an identifier (e.g., first twelve digits, etc.). When the range is reassigned, the data issuers 102a-c and/or the data repository 104 is/are configured to compile an updated instruction, which includes the range and new supplemental data, such as a designator, to be updated in the data structure/data repository 104. An example update instruction is provided in Table 3. In this example update instruction, the designators ID_1 and ID_2 are the only supplemental data to be updated. In other update instructions, additional supplemental data (e.g., any data related to the data issuers 102a-c, or not, etc.) may further be updated.

TABLE 3

| Starting | Ending | | |
|---|---|---|---|
| Identifier | Identifier | ID_1 | ID_2 |
| 5555 5555 5546 | 5555 5555 5547 | 1234 | 1234 |
| 0000 | 0000 | | |

It should be understood that the update instructions may include multiple rows, each being specific to a reassigned range and the supplemental data to be updated, etc.

In response to the update instruction, the data repository 104 is configured to update the data structure, which includes those identifiers, and in particular, update the supplemental data for the identifiers.

In particular, for each identifier in a range of identifiers, the data repository 104 is configured to determine whether the first segment of the starting identifier ends with a zero, and the first segment of the ending identifier ends with a nine. If yes, the data repository 104 is configured to determine if the second segment of the starting identifier and the ending identifier are the same. If yes, the data repository is configured to update the designators ID_1 and ID_2, in this example, for each of the identifiers having the same second segment. If no, the data repository is configured to update the designators ID_1 and ID_2, in this example, for each of the identifiers which includes a second segment between the second segment of the starting identifier and the second segment of the ending identifier.

Further, if the first segment of the starting identifier does not end with a zero and/or the first segment of the ending identifier does not end with a nine, the data repository 104 is configured to determine if the second segment of the starting identifier is the same as the second segment of the ending identifier. If yes, the data repository 104 is configured to generate a hash value for each first segment, in sequence, from the starting identifier to the ending identifier. The data repository 104 is then configured to update the designators for each entry in the data structure for which the second segment is the same as the second segment of the starting identifier (which is the same as the second segment of the ending identifier), and which also matches one of the generated hash values.

If the second segment of the starting identifier is not the same as the second segment of the ending identifier, the data repository 104 is configured to determine whether the first segment of the starting identifier ends with a zero. If yes, the data repository 104 is configured to reduce the last digit of the first segment of the starting identifier by one, to generate a hash value for the reduced first segment, and to include the hashed value in an exclusion list. The data repository is configured to incrementally reduce the first segment by one, each time generating the hash value and adding the hashed value to the exclusion list until the last digit of the first segment is zero. Next, the data repository 104 is configured to determine whether the first segment of the ending identifier ends with a nine. If yes, the data repository 104 is configured to increase the last digit of the first segment of the ending identifier by one, to generate a hash value for the increased first segment, and to include the hashed value in an exclusion list. The data repository 104 is configured to incrementally increase the first segment by one, each time generating the hash value and adding the hashed value to the exclusion list until the last digit of the first segment is nine. Thereafter, the data repository 104 is configured to update the designators for each identifier in the data structure which includes a second segment in the range between the starting identifier and the ending identifier, if the hashed value for that identifier is not included in the exclusion list.

In this way, the designators are updated in the data structure to indicate the data issuer 102a-c, to which the identifiers are reassigned without having to decrypt each of the encrypted identifiers in the data structure.

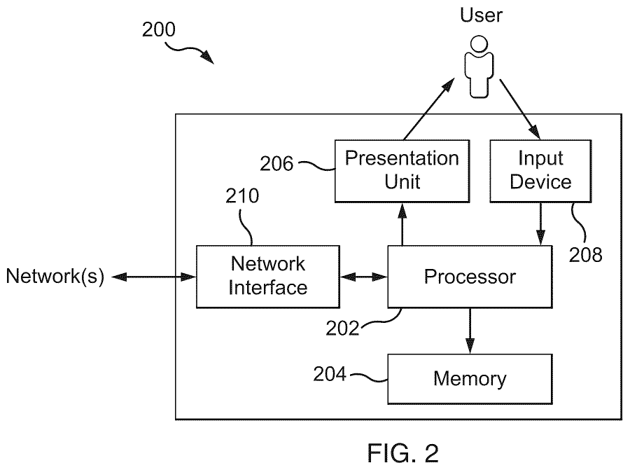

FIG. 2 illustrates an example computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In the example system 100, each of data issuers 102a-c and the data repository 104 should be understood to be included in, or being implemented in, a computing device consistent with the computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. In addition, as described above with reference to the databases 102a-c, the memory 204 may include a memory architecture, not only as a physical device, but also an arrangement of physical devices located together or spread across a geographic region. With that said, the memory 204 may be configured, as one or more data structures, to store, without limitation, identifiers or segments thereof, supplemental data (e.g., designators, etc.), hashed values, encrypted identifiers, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer-readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the example embodiment, the computing device 200 includes an output device 206 that is coupled to (and is in communication with) the processor 202. The output device 206 outputs information (e.g., updated data structures, etc.), visually, or audibly, for example, to a user of the computing device 200. It should be further appreciated that various interfaces may be displayed at computing device 200, and in particular at output device 206, to display certain information. The output device 206 may include, without limitation, a liquid crystal display (LCD), a light-emitting diode (LED) display, an organic LED (OLED) display, an “electronic ink” display, speakers, etc. In some embodiments, the output device 206 may include multiple devices.

The computing device 200 also includes an input device 208 that receives inputs from the user (i.e., user inputs) such as, for example, entries of ranges to be reassigned, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, etc. Further, in various example embodiments, a touch screen, such as that included in a tablet, a smartphone, or similar device, behaves as both an output device and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks. Further, in some example embodiments, the computing device 200 may include the processor 202 and one or more network interfaces incorporated into or with the processor 202.

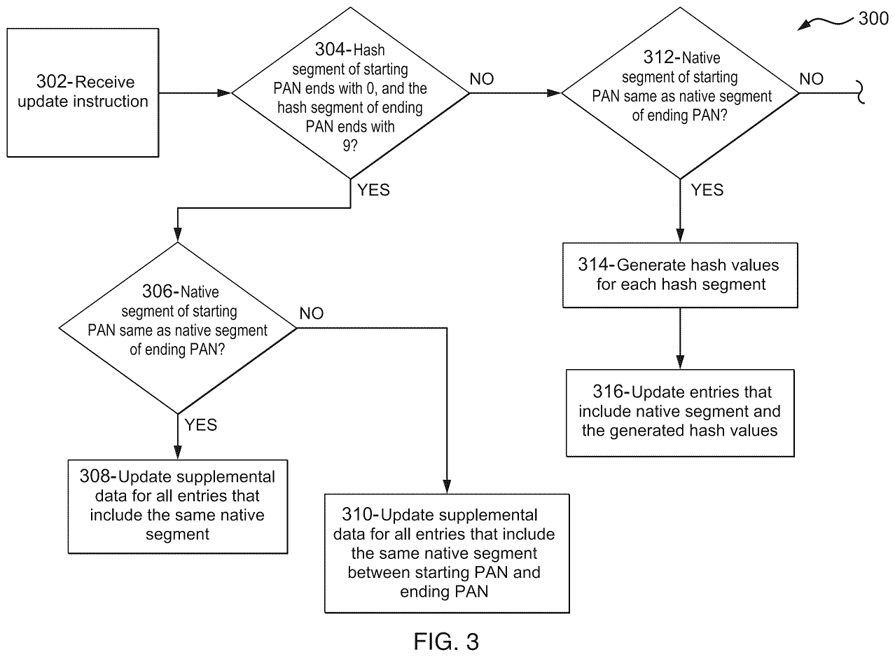

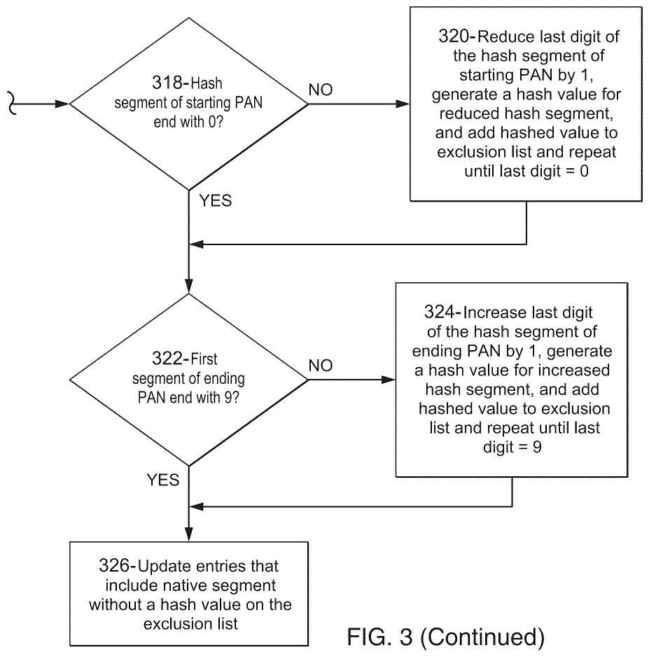

FIG. 3 illustrates an example method 300 for updating a data structure based on an update instruction related to a reassigned identifier range. The example method 300 is described as implemented in the data repository 104 of the system 100. However, the method 300 is not limited to the data repository 104, or more generally, to the system 100. Further, the example method 300 is described herein with reference to the computing device 200. But the methods herein should not be understood to be limited to the example computing device 200. Likewise, the systems and computing devices herein should not be understood to be limited to the example method 300.

At the outset, it should be understood that the data repository 104 includes a data structure, which includes one hundred thousand entries (or more), each including a unique identifier. In other embodiments, however, the data structure may include a different number of entries (e.g., more than one thousand, ten thousands, two hundred thousands, one million, ten million, one hundred million, etc.). Each entry includes an encrypted identifier, a native segment of the identifier and various supplemental data. As each entry is created, the data repository 104 generates a hash value for the hash segment of the identifier and also stores the hash value in the entry.

Further, in this embodiment, the supplemental data includes two designators for a data generator (e.g., ID_1 and ID_2, etc.) to which the identifier is assigned. Further still, in the example of FIG. 3, the identifiers are each PANs, which include a 16 digit numeric format. The PANs may be assigned to ranges having at least 100,000 PANs. As such, each range includes at least one unique eleven digit segment in the PAN, whereby the hash segment of the PAN is eleven digits. Also, the applicable security standard permits up to ten digits to be stored in native form, whereby the native segment of the PAN is ten digits.

It should be appreciated that the hash segment and the native segment may be other lengths in other embodiments depending on, potentially, the format of the identifier and/or applicable security standard for storing the same.

To initiate the method 300, the data repository 104 receives, at 302, an update instruction for a range of PANs. The updated instruction may be received, for example, from the data issuer 102b, in connection with the range of PANs being reassigned to that data generator, or may be compiled by the data repository 104 in connection with reassigning the range of PANs. The reassignment may be related to, for example, changing a program associated with the PANs (e.g., from gold to platinum accounts, etc.). The update instruction includes a starting PAN and the ending PAN for the range of PANs. The starting and ending PANs may be full PANs, or only a part thereof. In addition, the update instruction includes the supplemental data to be updated, such as, for example, designations of the new data generator, etc.

In response, the data repository 104 determines, at 304, whether the hash segment of the starting PAN ends with a zero, and the hash segment of the ending PAN ends with a nine.

If yes, the data repository 104 determines, at 306, whether the native segment of the starting PAN and the ending PAN are the same.

If yes, the data repository 104 updates, at 308, the supplemental data for all entries in the data structure that includes the same native segment. That is, in this example, the data repository 104 proceeds entry by entry through the data structure and, for each entry, appends designators for the new data generator to the entry, in place of the older designators for the prior data generator, when the native segment of the PAN of the entry matches the native segment of the starting and ending PANs.

As shown in FIG. 3, if the native segment of the starting PAN and the ending PAN are not the same, the data repository 104 updates, at 310, the supplemental data for entries in the data structure that include the same native segment between the starting PAN and the ending PAN. That is, where the starting PAN and ending PAN include multiple different native segments therebetween, the data repository 104 checks each of the native segments, as the data repository proceeds entry by entry through the data structure, and appends the designators, as above. For example, where the range of PANs includes 5555 5555 1200 0000 to 5555 5555 1690 000, the range includes the following unique native segments: 5555 5555 12, 55555 5555 13, 5555 5555 14, 5555 5555 15, and 5555 5555 16. Any entry which includes these native segments would also be updated with the new designators, at 310.

If, at step 304, the hash segment of the starting PAN does not end with a zero, and the hash segment of the ending PAN does not end with a nine, the data repository 104 determines, at 312, whether the native segment of the starting PAN is the same as the native segment of the ending PAN. If yes, the data repository generates, at 314, a hash value for each hash segment, in sequence, included in the starting PAN up to the ending PAN. The data repository 104 then updates, at 316, the supplemental data for all entries in the data structure, which include 1) a hash value matching one of the generated hash values, and 2) the same native segment of the starting PAN (which is the same as the second segment of the ending PAN). Again, the data repository 102 proceeds entry by entry through the data structure and appends the designators where the two conditions are satisfied.

However, if the native segment of the starting PAN is not the same as the native segment of the ending PAN at step 312, the data repository 104 determines, at 318, whether the hash segment of the starting PAN ends with a zero. If yes, at 320, the data repository 104 reduces the last digit of the first segment of the starting PAN by one, to generate a hash value for the reduced first segment, and to add the hashed value to an exclusion list. In doing so, the data repository 104 incrementally proceeds to reduce the hash segment by one, each time generating the hash (or hashed) value and adding the hashed value to the exclusion list, until the last digit of the native segment is zero.

Next, the data repository 104 determines, at 322, whether the hash segment of the ending PAN ends with a nine. If yes, at 324, the data repository 104 increases the last digit of the hash segment of the ending PAN by one, generates a hash value for the increased hash segment, and includes the hashed value in an exclusion list. Step 324 is repeated, with the hash segment being increased each time, until the last digit of the first segment is nine. Thereafter, the data repository 104 updates, at 326, the supplemental data for each entry in the data structure, which includes a native segment in the range between the starting PAN and the ending PAN (as in step 310) but does not include any of the hash values included in the exclusion list. In particular, the data repository 104 proceeds entry by entry through the data structure and determines if the native segment is a match for the range of PANs, and then checks to determine if the hashed value is in the exclusion list. If no, the data repository 104 appends the designators for the data generator 102b in place of the old designatory in that entry.

Upon completion of method 300, at steps 308, 310, 316, or 326, the data structure is updated, and the designators for the new data generator are corrected throughout the one hundred thousand entries of the data structure.

In this way, the designators are updated to indicate the data issuer 102a-c, to which the PANs are reassigned, without having to decrypt each of the PANs. That is, in the example described with reference to FIG. 3, the data structure includes one hundred thousand entries. The data structure then includes one hundred thousand encrypted PANs. Apart from method 300, the data repository 104 would be required to decrypt all one hundred thousand PANs in order to update the supplemental data. Yet, with the advent of method 300, the data repository 104 is only required to hash a handful of hash segments (and increment or decrement thereof) in order to update the supplemental data in the entire data structure. As such, there is a substantial processing savings through implementation of the method 300.

In view of the above, the systems and method herein provide substantial processing savings in connection with updating supplemental data in a data structure including encrypted identifiers. That is, the decryption of the identifiers for a data structure with thousands or millions of entries includes processing of thousands or millions of description. The same identification is performed, as described above, with identical accuracy with only dozens of operations (e.g., hashing, comparisons, etc.). This is a technical advancement by achieving the same result in a unique manner that yields substantial processing savings.

Again and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) based on an update instruction for a range of identifiers including a starting identifier and an ending identifier, determining, by a computing device, that a native segment of the starting identifier is the same as a native segment of the ending identifier; (b) in response to the native segment of the starting identifier being the same as the native segment of the ending identifier: generating, by the computing device, e a hash value for each hash segment of the range of identifiers; and updating, by the computing device, supplemental data, for each entry of the data structure which includes the native segment of the starting identifier and one of the generated hash values for the range of identifiers, without decrypting an encrypted one of the range of identifiers in said entry; (c) in response to the update instruction, prior to determining whether the native segment of the starting identifier is the same as the native segment of the ending identifier: determining, by the computing device, that i) a hash segment of the starting identifier ends in 0 and ii) a hash segment of the ending identifier ends in 9; and based on the hash segment of the starting identifier ending in 0 and the hash segment of the ending identifier ending in 9: determining, by the computing device, that the native segment of the starting identifier is the same as the native segment of the ending identifier; and in response to determining that the native segment of the starting identifier is the same as the native segment of the ending identifier, updating, by the computing device, the supplemental data for each of the entries in the data structure which include the native segment of the starting identifier; and/or (d) in response to the update instruction, prior to determining whether the native segment of the starting identifier is the same as the native segment of the ending identifier: determining, by the computing device, that i) a hash segment of the starting identifier ends in 0 and ii) a hash segment of the ending identifier ends in 9; and based on the hash segment of the starting identifier ending in 0 and the hash segment of the ending identifier ending in 9: determining, by the computing device, that the native segment of the starting identifier is not the same as the native segment of the ending identifier; and in response to determining that the native segment of the starting identifier is not the same as the native segment of the ending identifier, updating, by the computing device, the supplemental data for each of the entries in the data structure, which includes any of the native segments between the native segment of the starting identifier and the ending identifier.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in updating supplemental data in a data structure with encrypted identifiers, the system comprising:
a data repository computing device including a memory having a data structure and a processor, which is coupled to the memory and configured, by executable instructions, to:
based on an update instruction for a range of identifiers including a starting identifier and an ending identifier, determine whether a native segment of the starting identifier is the same as a native segment of the ending identifier;
in response to the native segment of the starting identifier being the same as the native segment of the ending identifier:
generate a hash value for each hash segment of the range of identifiers; and
update supplemental data, for each entry of the data structure which includes the native segment of the starting identifier and one of the generated hash values for the range of identifiers, without decrypting an encrypted one of the range of identifiers in said entry.

2. The system of claim 1, wherein the hash segment includes a leading 11 digits of each of the identifiers; and
wherein the native segment includes a leading 10 digits of each of the identifiers.

3. The system of claim 1, wherein the processor is further configured, by the executable instructions, to:
in response to the update instruction, prior to determining whether the native segment of the starting identifier is the same as the native segment of the ending identifier:
determine whether i) a hash segment of the starting identifier ends in 0 and ii) a hash segment of the ending identifier ends in 9; and
based on the hash segment of the starting identifier ending in 0 and the hash segment of the ending identifier ending in 9:
determine whether the native segment of the starting identifier is the same as the native segment of the ending identifier;
in response to a determination that the native segment of the starting identifier is the same as the native segment of the ending identifier, update the supplemental data for each of the entries in the data structure which include the native segment of the starting identifier; and
in response to a determination that the native segment of the starting identifier is not the same as the native segment of the ending identifier, update the supplemental data for each of the entries in the data structure, which includes any of the native segments between the native segment of the starting identifier and the ending identifier.

4. The system of claim 3, wherein the processor is further configured, by the executable instructions, to:
in response to the determination that the native segment of the starting identifier is not the same as the native segment of the ending identifier:
determine whether the hash segment of the starting identifier ends in 0;
based on the hash segment of the starting identifier not ending in 0, a) reduce a last digit of the hash segment of the starting identifier by 1, b) generate a hash value for the reduced hash segment, c) add the hashed value to an exclusion list, and d) repeat a)-c) until a last digit of the hash segment is 0.

5. The system of claim 4, wherein the processor is further configured, by the executable instructions, to:
based on the hash segment of the starting identifier ending in 0:
determine whether the hash segment of the ending identifier ends in 9; and
based on the hash segment of the ending identifier not ending in 9, a) increase a last digit of the hash segment of the ending identifier by 1, b) generate a hash value for the increased hash segment, c) add the generated hash value to the exclusion list, and d) repeat a)-c) until as last digit of the hash segment is 9.

6. The system of claim 4, wherein the processor is further configured, by the executable instructions, to update the supplemental data for each of the entries in the data structure, which includes any of the native segments between the native segment of the starting identifier and the ending identifier, but not any of the hash values in the exclusion list.

7. A computer-implemented method for use in updating supplemental data in a data structure with encrypted identifiers, the method comprising:
based on an update instruction for a range of identifiers including a starting identifier and an ending identifier, determining, by a computing device, that a native segment of the starting identifier is the same as a native segment of the ending identifier;
in response to the native segment of the starting identifier being the same as the native segment of the ending identifier:
generating, by the computing device, e a hash value for each hash segment of the range of identifiers; and
updating, by the computing device, supplemental data, for each entry of the data structure which includes the native segment of the starting identifier and one of the generated hash values for the range of identifiers, without decrypting an encrypted one of the range of identifiers in said entry.

8. The computer-implemented method of claim 7, wherein the hash segment includes a leading 11 digits of each of the identifiers; and
wherein the native segment includes a leading 10 digits of each of the identifiers.

9. The computer-implemented method of claim 7, further comprising:
in response to the update instruction, prior to determining whether the native segment of the starting identifier is the same as the native segment of the ending identifier:
determining, by the computing device, that i) a hash segment of the starting identifier ends in 0 and ii) a hash segment of the ending identifier ends in 9; and
based on the hash segment of the starting identifier ending in 0 and the hash segment of the ending identifier ending in 9:
determining, by the computing device, that the native segment of the starting identifier is the same as the native segment of the ending identifier; and
in response to determining that the native segment of the starting identifier is the same as the native segment of the ending identifier, updating, by the computing device, the supplemental data for each of the entries in the data structure which include the native segment of the starting identifier.

10. The computer-implemented method of claim 7, further comprising:
in response to the update instruction, prior to determining whether the native segment of the starting identifier is the same as the native segment of the ending identifier:
determining, by the computing device, that i) a hash segment of the starting identifier ends in 0 and ii) a hash segment of the ending identifier ends in 9; and
based on the hash segment of the starting identifier ending in 0 and the hash segment of the ending identifier ending in 9:
determining, by the computing device, that the native segment of the starting identifier is not the same as the native segment of the ending identifier; and
in response to determining that the native segment of the starting identifier is not the same as the native segment of the ending identifier, updating, by the computing device, the supplemental data for each of the entries in the data structure, which includes any of the native segments between the native segment of the starting identifier and the ending identifier.

11. The computer-implemented method of claim 10, further comprising:
in response to determining that the native segment of the starting identifier is not the same as the native segment of the ending identifier:
determining, by the computing device, that the hash segment of the starting identifier ends in 0;
based on the hash segment of the starting identifier not ending in 0, a) reducing, by the computing device, a last digit of the hash segment of the starting identifier by 1, b) generating, by the computing device, a hash value for the reduced hash segment, c) adding, by the computing device, the hashed value to an exclusion list, and d) repeating a)-c) until a last digit of the hash segment is 0.

12. The computer-implemented method of claim 11, further comprising:
based on the hash segment of the starting identifier ending in 0:
determining, by the computing device, that the hash segment of the ending identifier does not end in 9; and
based on the hash segment of the ending identifier not ending in 9, a) increasing, by the computing device, a last digit of the hash segment of the ending identifier by 1, b) generating, by the computing device, a hash value for the increased hash segment, c) adding, by the computing device, the generated hash value to the exclusion list, and d) repeating a)-c) until as last digit of the hash segment is 9.

13. The computer-implemented method of claim 11, further comprising updating the supplemental data for each of the entries in the data structure, which includes any of the native segments between the native segment of the starting identifier and the ending identifier, but not any of the hash values in the exclusion list.

14. A non-transitory computer-readable storage medium comprising executable instructions, which when executed by at least one processor of a data repository computing device in connection with updating supplemental data in a data structure with encrypted identifiers, cause the at least one computing device to:
based on an update instruction for a range of identifiers including a starting identifier and an ending identifier, determine whether a native segment of the starting identifier is the same as a native segment of the ending identifier;
in response to the native segment of the starting identifier being the same as the native segment of the ending identifier:
generate a hash value for each hash segment of the range of identifiers; and
update supplemental data, for each entry of the data structure which includes the native segment of the starting identifier and one of the generated hash values for the range of identifiers, without decrypting an encrypted one of the range of identifiers in said entry.

15. The non-transitory computer-readable storage medium of claim 14, wherein the hash segment includes a leading 11 digits of each of the identifiers; and
wherein the native segment includes a leading 10 digits of each of the identifiers.

16. The non-transitory computer-readable storage medium of claim 14, wherein the executable instructions, when executed by the at least one processor, further cause the at least one processor to:
in response to the update instruction, prior to determining whether the native segment of the starting identifier is the same as the native segment of the ending identifier:
determine whether i) a hash segment of the starting identifier ends in 0 and ii) a hash segment of the ending identifier ends in 9; and
based on the hash segment of the starting identifier ending in 0 and the hash segment of the ending identifier ending in 9:
determine whether the native segment of the starting identifier is the same as the native segment of the ending identifier;
in response to a determination that the native segment of the starting identifier is the same as the native segment of the ending identifier, update the supplemental data for each of the entries in the data structure which include the native segment of the starting identifier; and
in response to a determination that the native segment of the starting identifier is not the same as the native segment of the ending identifier, update the supplemental data for each of the entries in the data structure, which includes any of the native segments between the native segment of the starting identifier and the ending identifier.

17. The non-transitory computer-readable storage medium of claim 16, wherein the executable instructions, when executed by the at least one processor, further cause the at least one processor to:
in response to the determination that the native segment of the starting identifier is not the same as the native segment of the ending identifier:
determine whether the hash segment of the starting identifier ends in 0;
based on the hash segment of the starting identifier not ending in 0, a) reduce a last digit of the hash segment of the starting identifier by 1, b) generate a hash value for the reduced hash segment, c) add the hashed value to an exclusion list, and d) repeat a)-c) until a last digit of the hash segment is 0.

18. The non-transitory computer-readable storage medium of claim 17, wherein the executable instructions, when executed by the at least one processor, further cause the at least one processor to:
based on the hash segment of the starting identifier ending in 0:
determine whether the hash segment of the ending identifier ends in 9; and
based on the hash segment of the ending identifier not ending in 9, a) increase a last digit of the hash segment of the ending identifier by 1, b) generate a hash value for the increased hash segment, c) add the generated hash value to the exclusion list, and d) repeat a)-c) until as last digit of the hash segment is 9.

19. The non-transitory computer-readable storage medium of claim 17, wherein the executable instructions, when executed by the at least one processor, further cause the at least one processor to update the supplemental data for each of the entries in the data structure, which includes any of the native segments between the native segment of the starting identifier and the ending identifier, but not any of the hash values in the exclusion list.
